(19) United States
(12) Patent Application Publication
(10) Pub. No.: US 2008/0028787 A1
(43) Pub. Date: Feb. 7, 2008

(54) Adsorption type heat exchanger and method of manufacturing the same

(75) Inventors: Hiroshi Mieda, Kariya-city (JP); Seiji Inoue, Nukata-gun (JP); Satoshi Inoue, Kariya-city (JP); Hisao Nagashima, Okazaki-city (JP); Masaaki Tanaka, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/888,078

(22) Filed: Jul. 31, 2007

(30) Foreign Application Priority Data
Aug. 2, 2006 (JP) 2006-211322

(51) Int. Cl. F25B 17/08; B23P 15/26

(52) U.S. Cl. 62/480; 165/104.15; 29/890.035

(57) ABSTRACT

An adsorption type heat exchanger includes a heat exchange part, in which a thermal medium circulates, and adsorbents made of particles. The adsorbents are fixed on an outer surface of the heat exchange part, to adsorb refrigerant vapor when a temperature of the thermal medium is low, and to desorb the adsorbed refrigerant vapor when the temperature of the thermal medium is high. In addition, percents of the adsorbents having particle sizes about in a range from 0 to 42 μm are about 90% and over of the whole adsorbents.

### CROSS REFERENCE TO RELATED APPLICATION

This application is based on Japanese Patent Application No. 2006-211322 filed on Aug. 2, 2006, the content of which is incorporated herein by reference in its entirety.

### BACKGROUND OF THE INVENTION

1. Field of the Invention

The present invention relates to an adsorption type heat exchanger and a method of manufacturing the same. The adsorption type heat exchanger can be used for an adsorber in an adsorption type refrigerator for a vehicle.

2. Description of the Related Art

An adsorption type heat exchanger adsorbs and desorbs refrigerant vapor from an outside. For example, JP-A-2000-329425 discloses an adsorption type heat exchanger including a heat exchange body, a plurality of adsorbents, and a cover member. The heat exchange body has a heat transfer pipe and a plurality of fin plates. The adsorbents are filled between the fin plates, and the cover member covers the heat exchange body for holding the adsorbents. In addition, the adsorption type heat exchanger includes a tension providing member attached to the cover member for providing a predetermined tension to the cover member. In this way, the adsorbents are held by a simple method, thereby the adsorbents certainly touch the fin plates without dropping from the fin plates.

However, the adsorption type heat exchanger in JP-A-2000-329425 requires the cover member for holding the adsorbents, thereby a number of components and a number of assembling processes are increased. In addition, the adsorbents may be dispersed due to a flow of refrigerant vapor. Furthermore, the adsorbents are filled between the fin plates, thereby a layer of the adsorbents may be thick, and a heat transfer performance of the adsorption type heat exchanger may be reduced.

### SUMMARY OF THE INVENTION

In view of the foregoing problems, it is an object of the present invention to provide an adsorption type heat exchanger in which adsorbents can be certainly fixed to a heat exchange part without an additional component, and a heat transfer performance between the heat exchange part and the adsorbents is improved. Another object of the invention is to provide a method of manufacturing the adsorption type heat exchanger.

An adsorption type heat exchanger according to an aspect of the invention includes a heat exchange part, in which a thermal medium circulates, and adsorbents made of particles. The adsorbents are fixed on an outer surface of the heat exchange part, to adsorb refrigerant vapor when a temperature of the thermal medium is low, and to desorb the adsorbed refrigerant vapor when the temperature of the thermal medium is high. In addition, percents of the adsorbents having particle sizes about in a range from 0 to 42 _{″}m are about 90% and over of the whole adsorbents.

In the adsorption type heat exchanger, each of the adsorbents receives a collision force due to a flow of refrigerant vapor, and its own gravity. When the adsorbents have minute particle sizes, van der Waals forces generate between the heat exchange part and the adsorbents, and among the adsorbents. In a case where a temperature of the refrigerant vapor is about 60° C., when the percents of the adsorbents having particle sizes about in the range from 0 to 42 _{″}m are about 90% and over of the whole adsorbents, the van der Waals forces become larger than the sum of the collision force and the own gravity. Therefore, the adsorbents can be certainly fixed to the heat exchange part without an additional component. Furthermore, when the adsorbents have the minute particle sizes, a layer of the adsorbents can be formed into very thin, thereby a thermal resistance of the adsorbents becomes small. As a result, a heat transfer performance between the heat exchange part and the adsorbents is improved.

### BRIEF DESCRIPTION OF THE DRAWINGS

Additional objects and advantages of the present invention will be more readily apparent from the following detailed description of preferred embodiments when taken together with the accompanying drawings. In the drawings:

FIG. 1 is a schematic cross-sectional view of an adsorber according to a first embodiment of the invention;

FIG. 2 is an enlarged view of adsorbents fixed to a heat exchange part of the adsorber;

FIG. 3 is a graph showing relationships between Reynolds numbers and drag coefficients;

FIG. 4 is a graph showing relationships between particle sizes of the adsorbents and forces working on the adsorbents according to the first embodiment of the invention;

FIG. 5 is a graph showing relationships between particle sizes of the adsorbents and forces working on the adsorbents according to a second embodiment of the invention;

FIGS. 6A and 6B are schematic cross-sectional views showing fins and the adsorbents according to a fifth embodiment of the invention; and

FIGS. 7A and 7B are schematic cross-sectional views showing the fins, the adsorbents, and adhesives according to a sixth embodiment of the invention.

### DETAILED DESCRIPTION OF THE PREFERRED EMBODIMENTS

### First Embodiment

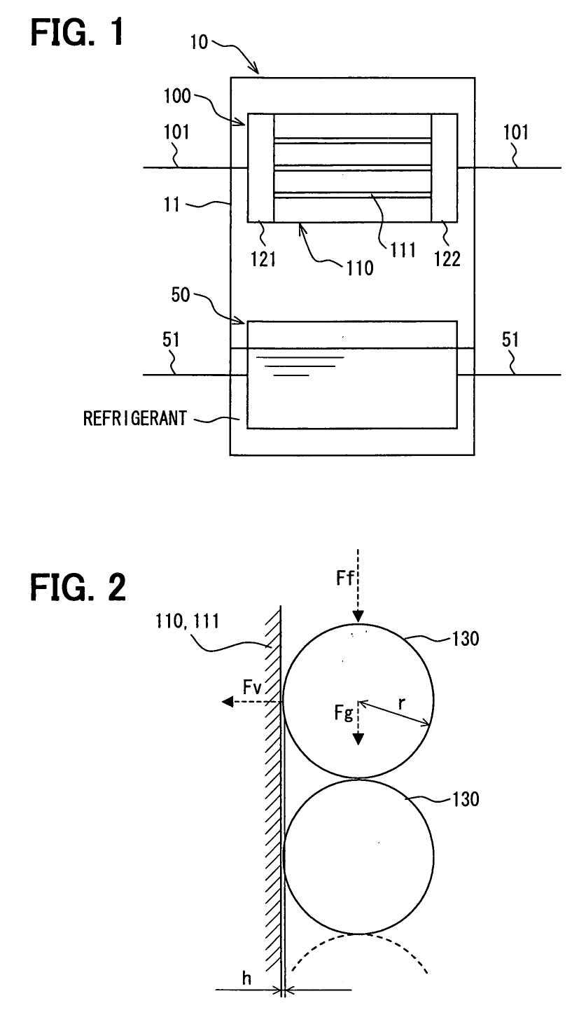

An adsorption type heat exchanger 100 according to a first embodiment of the invention will be described with reference to FIGS. 1-4. The adsorption type heat exchanger 100 can be used for an adsorber 10 in an adsorption type refrigerator for a vehicle, for example. The refrigerator has two adsorbers 10 which have similar structures and are used in pairs.

As shown in FIG. 1, the adsorber 10 has a closed container 11 in which a first heat exchanger 50, and the adsorption type heat exchanger (a second heat exchanger) 100 are disposed. The closed container 11 has an approximately rectangular parallelepiped shape made of a stainless material or an iron material, for example. The closed container 11 is kept in an approximately vacuum state and has therein a refrigerant (e.g., water). An amount of the refrigerant filled in the closed container 11 is set so that a liquid surface of the refrigerant is positioned on a downside in the closed container 11. Thus, the closed container 11 has a space at an upside side portion thereof.

The first heat exchanger 50 has a heat exchange part (not shown) and first pipes 51 connected to the heat exchanger part. The heat exchange part has fins and tubes which are alternately stacked. The first pipes 51 are connected to the heat exchange part so that a first thermal medium flows from one of the first pipes 51 to another one of the first pipes 51 through the heat exchange part. Each of components (the fin, the tubes, and the first pipes 51) of the first heat exchanger 50 is made of aluminum, or an aluminum alloy, for example. The components are assembled and brazed to form the first heat exchanger 50.

The first heat exchanger 50 is arranged at a lower side portion in the closed container 11 so that at least a part of the first heat exchanger 50 is soaked in the refrigerant. Each of the first pipes 51 penetrates through the closed container 11 and extends to an outside. The first pipes 51 and the closed container 11 are sealed with seal members made of a rubber or a resin, for example, for keeping the approximately vacuum state in the closed container 11.

The second heat exchanger 100 has a heat exchange part 110 and tanks 121 and 122. The heat exchange part 110 includes a plurality of tubes 111 which are stacked. Two longitudinal ends of each of the tubes 111 are connected with tanks 121 and 122 so that an inside of each of the tubes 111 communicates with insides of the tanks 121 and 122. In addition, adsorbents 130 are fixed on surfaces of the tubes 111. The adsorbents 130 have particle shapes and are made of silica gel, zeolite, activated carbon, and activated alumina, for example. The second heat exchanger 100 is arranged in the space which is provided at an upper side portion in the closed container 11 (i.e., upper side of the first heat exchanger 50). The second heat exchanger 100 has second pipes 101. The second pipes 101 are connected to the heat exchange part 110 so that a second thermal medium (e.g., cooling water or hot water) flows from one of the second pipes 101 to another one of the second pipes 101 through the heat exchange part 110. Each of the second pipes 101 penetrates through the closed container 11 and extends to an outside. The second pipes 101 and the closed container 11 are sealed with seal members similarly with those in the first heat exchanger 50.

In one of the two adsorbers 10, when the refrigerant in the closed container 11 evaporates, the first thermal medium circulated in the first heat exchanger 50 is cooled by an evaporative latent heat of the refrigerant, and the cooled first thermal medium flows to an interior heat exchanger (not shown) for cooling air for the refrigerator. In addition, the evaporated refrigerant (refrigerant vapor) in the closed container 11 is adsorbed by the adsorbents 130 of the second heat exchanger 100, and heat of the refrigerant vapor is transmitted to the second thermal medium (cooling water) circulated in the second heat exchanger 100 and is released to the outside.

In another one of the two adsorbers 10, the refrigerant vapor adsorbed to the adsorbents 130 of the second heat exchanger 100 is heated and desorbed by the second thermal medium (hot water). Furthermore, the refrigerant vapor desorbed from the adsorbents 130 is cooled and condensed by the first thermal medium circulated in the first heat exchanger 50, on surfaces of the heat exchanger 50, which are not soaked in the refrigerant.

Each of the first heat exchangers 50 of the two adsorbers 10 is operated to evaporate and condense the refrigerant alternately, so that air for the refrigerator can be continuously cooled by using the first thermal medium which is cooled by one of the first heat exchangers 50 which evaporates the refrigerant.

Next, a method for fixing each of the adsorbents 130 to the second heating part 110 (i.e., the tubes 111) will be described. As shown in FIG. 2, the adsorbent 130 receives a collision force “Ff” of the refrigerant vapor when the refrigerant vapor is desorbed (i.e., when a temperature of the second thermal medium is high), and its own gravity “Fg”. Furthermore, the adsorbent 130 receives a van der Waals force “Fv”. The van der Waals force “Fv” is determined in accordance with a radius “r” of the adsorbent 130, and a distance “h” between the adsorbent 130 and a wall surface of the tube 111. The van der Waals force “Fv” works on the adsorbent 130 as an adherence.

Thus, when the absolute value of the van der Waals force “Fv” is larger than the absolute value of the sum of the collision force “Ff” and the own gravity “Fg”, the adherence of the adsorbent 130 is provided. The collision force “Ff”, the own gravity “Fg”, and the van der Waals force “Fv” are calculated from following formulas (1)-(3).

Ff=C_{D}×(ρv/2)×v²×S (1)

Fg=mg=ρa×V×g(N) (2)

Fv=−A/6{r/h²+r/(h+2r)²−1/h+1/(h+2r)}−Ar/6h² (3)

In formula (3):

A=20e⁻²⁰ (J); and

h=4e⁻¹⁰ (m)

In above formulas (1)-(3):

“C_{D}” is a drag coefficient;

“ρv” is a density (kg/m³) of refrigerant vapor;

“v” is a flow rate (m/s) of refrigerant vapor;

“S” is a maximum projected area (m²) in a flow direction;

“m” is a weight (kg) of the adsorbent 130;

“ρa” is a density (kg/m³) of the adsorbent 130;

“V” is a volume (m³) of the adsorbent 130;

“g” is a gravitational acceleration (m/s²);

“A” is a Hamaker coefficient (J);

“r” is the radius (m) of the adsorbent 130; and

“h” is the distance (m) between the adsorbent 130 and the wall surface of the tube 111.

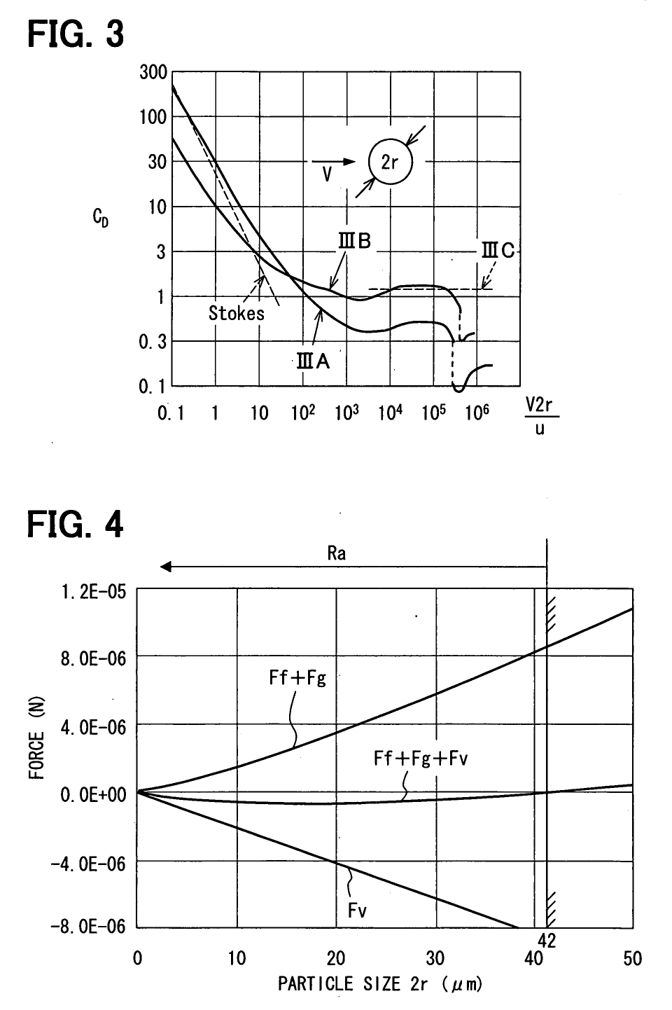

FIG. 3 shows relationships between Reynolds numbers “Re” and drag coefficients “C_{D}” in cases where a particle has a sphere shape (IIIA), a column shape (IIIB), or a disk shape (IIIC). Thus, in formula (1), “C_{D}” is calculated from the Reynolds number “Re” shown by the line IIIA, and the Reynolds number “Re” is calculated from formula (4).

Re=v2r/u (4)

Wherein, “u” is a kinematic viscosity coefficient (m²/s). Furthermore, in formula (4), the flow rate “v” of refrigerant vapor is about a sound speed. Therefore, the flow rate “v” of refrigerant vapor is calculated from formula (5).

v=(κRT)^{0.5} (5)

In formula (5):

“κ” is a ratio of specific heat;

“R” is a gas constant (J/gK); and

“T” is a temperature (K) of refrigerant vapor.

When the adsorbent 130 is heated by the second thermal medium such as waste heat about at 70° C., temperatures of the refrigerant vapor and the adsorbent 130 become lower than a temperature of the second thermal medium by about 10° C., thereby the temperature of the refrigerant vapor becomes about 60° C. at a maximum.

When a particle size (2r) of the adsorbent 130 is set to be variable, and the collision force “Ff”, the own gravity “Fg”, and the van der Waals force “Fv” are calculated from formula (1)-(5), the sum of the forces (Ff+Fg+Fv) can be calculated and a graph shown in FIG. 4 can be obtained. When the particle size of the adsorbent 130 is about in a range “Ra” from 0 to 42 μm, the sum of the forces is in a minus area in FIG. 4. In other words, when the particle size of the adsorbent 130 is about in the range “Ra” from 0 to 42 μm, the absolute value of the van der Waals force “Fv” becomes larger than the absolute value of the sum of the collision force “Ff” and the own gravity “Fg”, thereby the adhesion of the adsorbent 130 to the tube 111 due to the van der Waals force “Fv” can be obtained. Therefore, the adsorbent 130 can be prevented from detaching from the tube 111 by the refrigerant vapor. In addition, when percents of the adsorbents 130 having particle sizes about in the range “Ra” from 0 to 42 μm are about 90% and over of the whole adsorbents 130, the adsorbents 130 can be fixed to the tubes 111 without a practical issue.

Furthermore, the line showing the sum of the forces (Ff+Fg+Fv) has a down-curved shape, as shown in FIG. 4. Thus, when the particle size of the adsorbent 130 is about in a range from 10 to 30 μm, the adhesion due to the van del Waals force “Fv” becomes large.

For example, when the particle size of the adsorbent 130 is set to be about 17 μm, formulas (1)-(5) are calculated as follows.

At first, the flow rate “v” of refrigerant vapor is calculated from formula (5).

v=(κRT)^{0.5}={1.327×(8.314/0.018)×333.15}^{0.5}=451.88 (m/s)

The Reynolds number “Re” is calculated from formula (4).

Re=v2r/u=(451.88×2×8.5e⁻⁶)/8.4e⁻⁵=91.28

Thus, from the line IIIA in FIG. 3, the drag coefficient “C_{D}” becomes about 0.953.

The collision force “Ff” is calculated from formula (1).

Ff=C_{D}×(ρv/2)×v²×S=0.953×(0.130/2)×451.88²×2.27e⁻¹⁰=2.87e⁻⁶ (N)

The own gravity “Fg” is calculated from formula (2).

Fg=mg=ρa×V×g=900×2.57e⁻¹⁵×9.8=2.27e⁻¹¹ (N)

Furthermore, the van der Waals force “Ff” is calculated from formula (3).

Fv=−A/6{r/h²+r(h+2r)²−1/h+1/(h+2r)}−Ar/6h²=−(2e⁻¹⁹/6)×{8.5e⁻⁶×(4e⁻¹⁰)²+8.5e⁻⁶/(4e⁻¹⁰+2×8.5e⁻⁶)²−1/4e⁻¹⁰+1/(4e⁻¹⁰+2×8.5e⁻⁶)}−2e⁻¹⁹×8.5e⁻⁶/{6×(4e⁻¹⁰)²}=−3.54e⁻⁶ (N)

Therefore, the sum of the forces working on the adsorbent 130 is calculated.

Ff+Fg+Fv=−0.67e⁻⁶ (N).

In the adsorption type heat exchanger (the second heat exchanger) 100 having the adsorbents 130, when the particle sizes of the adsorbents 130 are minute, the van der Waals force “Fv” is generated between the heat exchange part 110 (the tubes 111) and the adsorbents 130, and among the adsorbents 130. In a case where the temperature of the refrigerant is about 60° C., when the percents of the adsorbents 130 having particle sizes about in the range “Ra” from 0 to 42 μm is set to be about 90% and over of the whole adsorbents 130, the absolute value of the van der Waals force “Fv” becomes larger than the absolute value of the sum of the collision force “Ff” and the own gravity “Fg”. As a result, the adsorbent 130 can be certainly fixed to the heat exchange part 110 without an additional component such as a cover member.

Furthermore, when the particle sizes of the adsorbents 130 are minute, the adsorbents 130 can be formed into a very thin layer, thereby a thermal resistance of the adsorbents 130 becomes small. As a result, a heat transfer performance between the heat exchange part 110 (the tubes 111) and the adsorbents 130 can be improved.

### Second Embodiment

In a second embodiment, an upper limit of the temperature of the second thermal medium is set to be about 90° C. (e.g., a temperature of hot water of a vehicle engine). The temperatures of the adsorbents 130 and the refrigerant vapor are lower than that of the second thermal medium by about 10° C., thereby the temperature of the refrigerant vapor becomes about 60° C. at a maximum.

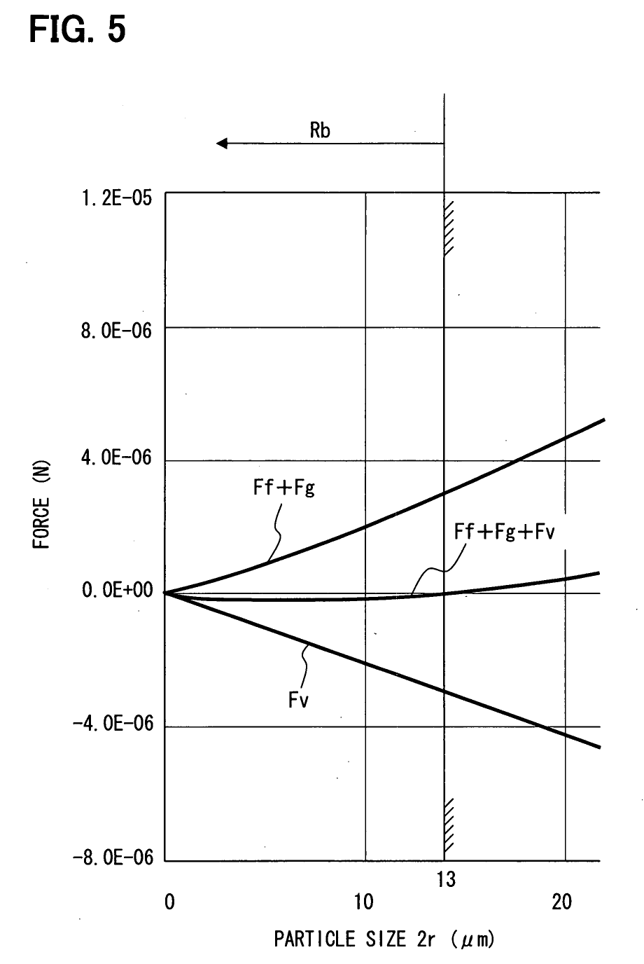

When the particle size (2r) of the adsorbent 130 is set to be variable, and the collision force “Ff”, the own gravity “Fg”, and the van der Waals force “Fv” are calculated from formula (1)-(5), the sum of the forces (Ff+Fg+Fv) can be calculated and a graph shown in FIG. 5 can be obtained. When the particle size of the adsorbent 130 is about in a range “Rb” from 0 to 13 μm, the absolute value of the van der Waals force “Fv” becomes larger than the absolute value of the sum of the collision force “Ff” and the own gravity “Fg”, thereby the adhesion of the adsorbent 130 to the tube 111 due to the van der Waals force “Fv” can be obtained. Therefore, the adsorbent 130 can be prevented from detaching from the tube 111 by refrigerant vapor. In addition, when the percents of the adsorbents 130 having particle sizes about in a range “Rb” from 0 to 13 μm is set to be about 90% and over of the whole adsorbents 130, the adsorbents 130 can be fixed to the tube 111 without a practical issue. Furthermore, as shown in FIG. 5, when the particle size of the adsorbent 130 is about in a range from 3 to 10 μm, the adhesion due to the van del Waals force “Fv” becomes large.

For example, when the particle size of the adsorbent 130 is set to be about 6 μm, formulas (1)-(5) are calculated as follows. The flow rate “v” of refrigerant vapor is calculated from formula (5).

v=(κRT)^{0.5}={1.325×(8.314/0.018)×353.15}^{0.5}=464.90 (m/s)

The Reynolds number “Re” is calculated from formula (4).

Re=v2r/u=(464.90×2×3e⁻⁶)/3.95e⁻⁵=70.62

Therefore, from the line IIIA in FIG. 3, the drag coefficient C_{D} becomes about 1.16.

The collision force “Ff” is calculated from formula (1).

Ff=C_{D}×(ρv/2)×v²×S=1.16×(0.293/2)×464.90²×2.83e⁻¹¹=1.04e⁻⁶ (N)

The own gravity “Fg” is calculated from formula (2).

Fg=mg=ρa×V×g=900×1.13e⁻¹⁶×9.8=9.97e⁻¹³ (N)

Furthermore, the van der Waals force “Fv” is calculated from formula (3).

Fv=−A/6{r/h²+r/(h+2r)²−1/h+1/(h+2r)}−Ar/6h²=−(2e⁻¹⁹/6)×{3e⁻⁶×(4e⁻¹⁰)²+3e⁻⁶/(4e⁻¹⁰+2×3e⁻⁶)²−1/4e⁻¹⁰+1/(4e⁻¹⁰+×3e⁻⁶)}−2e⁻¹⁹×3e⁻⁶/{6×(4e⁻¹⁰)²}=−1.25e⁻⁶ (N)

Therefore, the sum of the forces working on the adsorbent 130 is calculated.

Ff+Fg+Fv=−1.25e⁻⁶ (N).

### Third Embodiment

In the above-described first and second embodiments, the adsorbents 130 are fixed to the tubes 111 of the heat exchange part 11 0 only by the van der Waals force “Fv”. Alternatively, an adhesive may be provided for enhancing a fixed strength of the adsorbents 130 to the heat exchange part 110. In this case, an amount of the adhesive is set to be in a range that the filling density of the adsorbent 130 and a diffusion of the refrigerant vapor are not restricted by the adhesive.

### Fourth Embodiment

In the heat exchange part 110 in FIG. 2, the adsorbents 130 are arranged in a single layer on the tubes 111, for example. However, the van der Waals force “Fv” is also generated among the adsorbents 130, thereby the adsorbents 130 may be arranged in a multilayer without being limited to the single layer.

### Fifth Embodiment

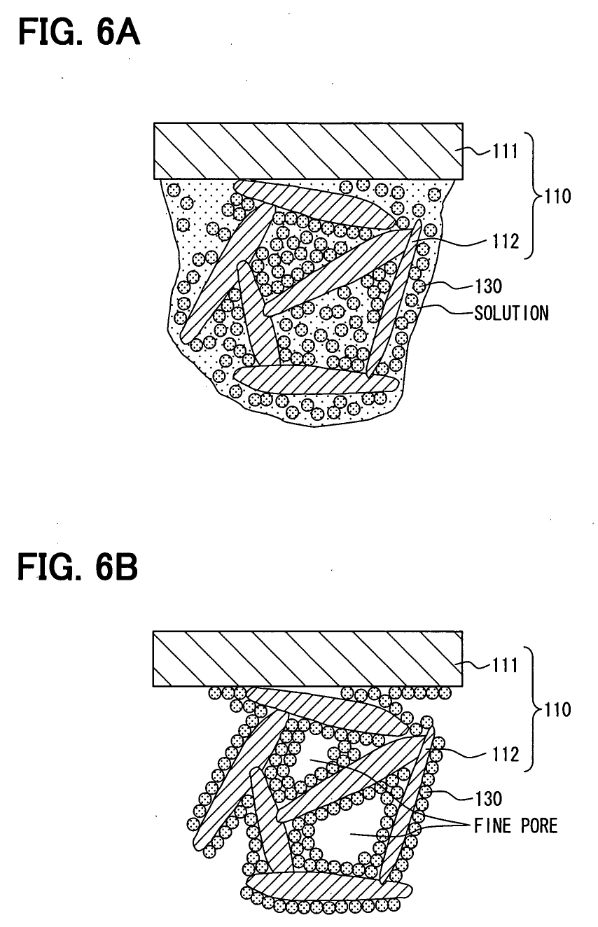

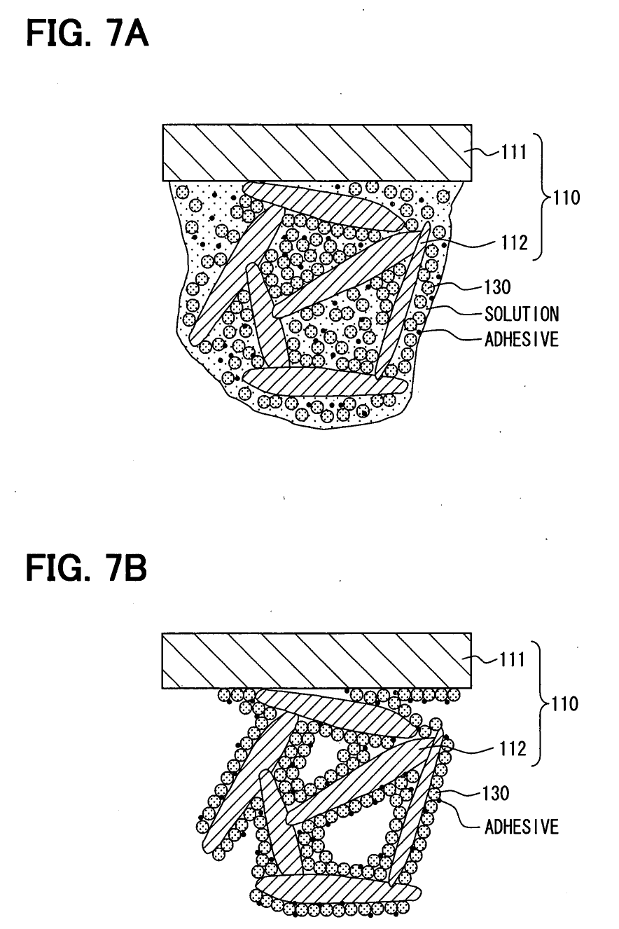

In the heat exchange part 110 in FIGS. 6A and 6B, fins 112 are provided to the tubes 111, and adsorbents 130 are fixed on surfaces of the fins 112 and the tubes 111.

For example, the fins 112 are made of porous material having fine pores. As a material for the porous fins 112, a sintered metal or a foam metal can be used, for example. The sintered metal is formed by sintering a metal powder having a good heat conductivity without melting. The foam metal is formed by sintering the metal powder with a foaming agent, and removing the foaming agent after sintering. The porous fins 112 are brazed to the tubes 111, and the adsorbents 130 are fixed on surfaces of the porous fins 112.

The adsorbents 130 are fixed on the porous fins 112 as follows. At first, the adsorbents 130 are dispersed in a solution to make a slurry. Then, the slurry is applied to the porous fins 112 so that the slurry fills in the surfaces of the porous fins 112 and insides of the fines pores, as shown in FIG. 6A. After the solution of the slurry is dried, the adsorbents 130 adhere to the surfaces of the porous fins 112 and insides of the fines pores, so that the adsorbents 130 are fixed by the van der Waals force “Fv”.

The minute fins 112 suited for the minute adsorbents 130 are easily formed by using the porous material. When the adsorbents 130 are fixed to the porous fins 112, the adsorbents 130 are mixed with the solution to make the slurry, and the slurry is applied to the surfaces of the porous fins 112 and insides of the fines pores, and after that, the solution of the slurry is dried. Therefore, a uniform layer of the adsorbent 130 can be easily formed on the complicated surface of the porous fins 112, thereby the second thermal medium can be heat exchanged with the refrigerant vapor by using a surface area of the porous fins 112 effectively. Furthermore, the refrigerant vapor can flow in the fine pores, thereby an adsorption rate of the refrigerant vapor is increased.

### Sixth Embodiment

When the adsorbents 130 are mixed with the solution to make the slurry, adhesives may be added. An amount of the adhesives is set to be in a range that the filling density of the adsorbents 130 and a diffusion of the refrigerant vapor are not restricted by the adhesives.

In this case, the adsorbents 130 are strongly fixed to the porous fins 112, and connections among the adsorbents 130 also become strong.

Such changes and modifications are to be understood as being within the scope of the present invention as defined by the appended claims.

What is claimed is:

1. An adsorption type heat exchanger comprising:
a heat exchange part, in which a thermal medium circulates; and
adsorbents made of particles, which are fixed on an outer surface of the heat exchange part, to adsorb refrigerant vapor when a temperature of the thermal medium is low, and to desorb the adsorbed refrigerant vapor when the temperature of the thermal medium is high; wherein:
percents of the adsorbents having particle sizes about in a range from 0 to 42 μm are about 90% and over of the whole adsorbents.

2. The adsorption type heat exchanger according to claim 1, wherein:
percents of the adsorbents having particle sizes about in a range from 0 to 13 μm are about 90% and over of the whole adsorbents.

3. The adsorption type heat exchanger according to claim 1, wherein:
the heat exchange part has fins for increasing a heat transfer area; and
the fins are made of a porous material having a plurality of fine pores.

4. The adsorption type heat exchanger according to claim 3, wherein:
the porous material includes a sintered metal.

5. The adsorption type heat exchanger according to claim 3, wherein:
the porous material includes a foam metal.

6. The adsorption type heat exchanger according to claim 3, wherein:
the adsorbents are fixed to the fins while having the fine pores.

7. The adsorption type heat exchanger according to claim 1, wherein:
a heat exchange part includes a plurality of tubes which are stacked; and
the adsorbents are fixed to outer surfaces of the tubes.

8. The adsorption type heat exchanger according to claim 7, wherein:
the tubes have fins for increasing a heat transfer area; and
the fins are made of a porous material having a plurality of fine pores.

9. A method of manufacturing the adsorption type heat exchanger according to claim 1, comprising:
mixing the adsorbents with a solution to make a slurry;
applying the slurry to the heat exchange part; and
drying the solution of the slurry.

10. The method of manufacturing the adsorption type heat exchanger according to claim 9, further comprising:
mixing an adhesive with the solution during the making of the slurry.
